(19) United States
(12) Patent Application Publication
(10) Pub. No.: US 2026/0188021 A1
(43) Pub. Date: Jul. 2, 2026

(54) STATIC OBJECT INFORMATION RETRIEVAL FROM A DYNAMIC GLOBAL MAP

(71) Applicant: QUALCOMM Incorporated, San Diego, CA (US)

(72) Inventors: Mudit JAIN, San Diego, CA (US); Varun RAVI KUMAR, San Diego, CA (US); Senthil Kumar YOGAMANI, San Diego, CA (US)

(21) Appl. No.: 19/003,700

(22) Filed: Dec. 27, 2024

(51) Int. Cl. G06V 20/58; G06F 16/29

(52) U.S. Cl. CPC G06V 20/582; G06F 16/29; G06V 2201/07

(57) ABSTRACT

The present disclosure provide techniques for object detection. A method may include obtaining a first frame, captured by a sensor from a first viewing angle, representing static object(s) in a scene during a first time period, wherein the static object(s) comprise a first static object; querying a data structure associated with a global map comprising sub-maps representing the scene for the first time period to identify a first sub-map of the sub-maps associated with a location of the sensor for the first time period; generating a second frame based on the first sub-map, the location of the sensor, and the first viewing angle of the sensor, the second frame representing at least the first static object in the scene during the first time period; and outputting the second frame. The second frame may be configured for use for object detection of at least the first static object in the scene.

### INTRODUCTION

### Field of the Disclosure

Aspects of the present disclosure relate to techniques for object detection.

### DESCRIPTION OF RELATED ART

The field of computer vision has observed significant advancements in recent years with the development of sophisticated perception systems that enable autonomous intelligent systems, such as autonomous vehicles (also simply referred to herein as “vehicles”) and/or robots, to perceive their surroundings. For example, a perception system of an autonomous vehicle may be used to sense and interpret an environment surrounding the vehicle through one or more sensors, such as to enable the vehicle to understand and/or safely navigate its environment. An example sensor installed at, or on, an autonomous vehicle may include a still or moving image sensor (e.g., a camera), light detection and ranging (LiDAR) equipment, a sound navigation and ranging (SONAR) sensor, a radio detection and ranging (RADAR) sensor, and/or the like.

One of the main tasks involved in achieving robust environmental perception in autonomous vehicles includes object detection. In the context of autonomous driving, object detection is a computer vision task used to localize and classify objects of interest, such as pedestrians, traffic elements (e.g., stoplights, traffic signs, road markings, and/or the like), other vehicles, barriers, etc., which may be in the area surrounding an autonomous vehicle. Localization may involve determining the location of an object in a frame (e.g., an image, a point cloud, etc.), while classification may involve assigning a class (e.g., “pedestrian,” “vehicle,” etc.) to that object. In many aspects, object detection is the foundation for other computer vision tasks during autonomous vehicle operation, such as object tracking, event detection, motion control, and path planning, among others.

### SUMMARY

Certain aspects provide a method for static object information generation. The method may include obtaining a first frame, captured by a sensor from a first viewing angle, representing one or more static objects in a scene during a first time period, wherein the one or more static objects comprise a first static object; querying a data structure associated with a global map comprising a plurality of sub-maps representing the scene for the first time period to identify a first sub-map of the plurality of sub-maps associated with a location of the sensor for the first time period; generating a second frame based on the first sub-map, the location of the sensor, and the first viewing angle of the sensor, the second frame representing at least the first static object in the scene during the first time period; and outputting the second frame

Certain aspects provide a method for object detection. The method may include sending a first frame, captured by a sensor from a first viewing angle, representing one or more static objects in a scene during a first time period, wherein the one or more static objects comprise a first static object; sending an indication of the first viewing angle and a location of the sensor associated with the first time period; receiving a second frame representing at least the first static object in the scene during the first time period, wherein the second frame is associated with the first viewing angle and a location of the sensor for the first time period; and processing the second frame to detect at least the first static object in the scene.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for static object information retrieval and detection.

FIG. 2 depicts an example of static object information retrieval using a dynamic global map.

FIG. 3 depicts an example of global map creation.

FIG. 4 depicts an example method for static object information generation.

FIG. 5 depicts an example method for object detection.

FIG. 6 depicts an example sensor and computing system.

FIG. 7 depicts aspects of an example apparatus.

FIG. 8 depicts aspects of another example apparatus.

### DETAILED DESCRIPTION

Aspects of the present disclosure provide apparatuses, methods, processing systems, and computer-readable mediums for constructing a dynamic global map, which may be leveraged for object detection by, for example, an autonomous vehicle. For example, information for a static object (e.g., an object that remains stationary over a period of time) in a scene may be retrieved from a global map and used to aid localization and classification of the object in the scene by the autonomous vehicle. In certain aspects, the static object may comprise an ambiguous static object, or a static object that can be interpreted in multiple ways, thereby making it difficult localize and classify as a single specific object in the scene. The information obtained from the global map may provide additional context for the static object, which may aid the autonomous vehicle in the localization and classification of the static object in the scene. It is noted that while certain aspects may be described herein with respect to autonomous vehicles, aspects of the present disclosure may likewise be applicable to other autonomous intelligent systems (e.g., robots).

Object detection may be divided into two main approaches: traditional object detection and deep learning (DL)-based object detection. Traditional object detection methods may rely on handcrafted features and specialized algorithms to identify objects within frames. These methods may rely on specific visual cues, which are manually defined, such as simple shapes, edges, textures, color patterns, shading, and/or the like to detect objects. For example, to detect a cherry depicted in a frame, the frame may be scanned for areas where the red component (R) in a red, green, blue (RGB) color model satisfies a threshold. Anything sufficiently red in the frame may be flagged as a potential cherry when using traditional object detection methods.

While effective for identifying limited types of objects in controlled environments, such as with minimal power consumption and complexity, traditional object detection methods may be inflexible and hard to use for general-purpose detection tasks, such as identifying multiple different kinds of objects at once and/or in different conditions.

DL-based methods provide a solution to overcome the aforementioned challenges of traditional based object detection. DL is a subset of machine learning (ML) that uses multilayered neural networks (e.g., artificial neural networks (ANNs), deep neural networks (DNNs), and/or convolutional neural networks (CNNs)) to simulate the complex decision-making power of the human brain. For example, the neural networks may consist of multiple layers of interconnected nodes, each building on a previous layer to refine and optimize prediction and/or categorization of the network. In general, DL-based object detection extracts features from an input frame and uses these extracted features to identify and locate objects within the input frame. For example, the neural network may progressively learn features in a frame, starting from simple features (e.g., such as edges, texture, corners, etc.) and moving to more complex patterns and structures (e.g., such as faces, cars, etc.). These learned features may be used to make predictions about one or more objects present in the frame, including their type(s) and/or position(s).

The performance of object detection methodologies, including traditional and DL-based object detection methods, may be influenced by numerous factors, such as object occlusion, object size, and visibility of objects in a frame (e.g., such as generated by a sensor located at or on an autonomous vehicle and configured to sense an environment surrounding the vehicle) used to perform the object detection.

Occlusion refers to when an object in a frame is partially or fully obscured by another object. Occlusion may present a technical challenge for object detection methods, as the obscured portion of an object is not visible, making it difficult to accurately detect and locate the object in the frame. The extent of the occlusion, as well as the type of occlusion, may impact the performance of object detection algorithms and/or models. For example, in some cases, the occluded portion of an object may be partially visible, thereby allowing object detection algorithms and/or models to make educated guesses about the shape and/or location of the object. However, in some other cases, an object may be almost completely obscured, making it challenging for the object detection algorithms and/or models to detect and locate the object.

Object size refers to a measurement of an object's dimensions or magnitude in a frame. Small objects in a frame may occupy fewer samples in the frame (e.g., fewer pixels in an image, fewer points in a point cloud, etc.); thus, there may be less information for an object detection model and/or algorithm to use for object detection and classification. Thus, extracting meaningful features may be challenging, and in some cases, may lead to failed detection and/or misclassification of such objects by the object detection model and/or algorithm.

Object visibility refers to the ability of a sensor (e.g., such as a sensor located at or on an autonomous vehicle) to detect and identify an object at a given distance (where there is no occlusion). Object visibility may be impacted by several factors, including but not limited to, weather conditions, lighting conditions, object color and intensity, and/or object damage.

For example, adverse weather, such as heavy rain, fog, and/or snow may reduce frame contrast, obscure finer object details, and/or result in frame blurring, which may reduce the sharpness of the frame thereby leading to loss of object information. In some cases, this information that is lost may be necessary for accurate object detection. Heavy rain may also produce sharp intensity changes in frames that may impair the performance of object detection models and/or algorithms that utilize these frames.

Extreme darkness (e.g., such as due to inadequate street lighting, etc.) and brightness may result in underexposed or overexposed regions in a frame, respectively, which may affect the overall frame quality and visibility of objects depicted in the frame. Further, fog may scatter light and reduce contrast in a frame, leading to haze that may influence sample values in a frame. Thus, without proper illumination, it may be challenging for objection detection models and/or algorithms to localize and classify objects in a frame, just as it is difficult for humans to localize these objects in similar lighting conditions.

Minimal color differences and/or brightness variations between objects and their surrounding backgrounds, captured in a frame, may also reduce object visibility, thereby increasing the difficulty of identifying and isolating such objects within the frame. For example, freshly painted road marking may be easier to spot, while road markings that have become worn and/or faded over time (e.g., such as due to exposure to sunlight, traffic, weather, etc.) may blend into other object(s) (e.g., the road) and become more difficult to detect.

Object damage refers to physical destruction and/or deterioration to an object, which may cause a loss of functionality and/or value to the object. Example object damage may include cracks, scratches, breaks, and/or other visible signs of impairment. In some cases, this impairment may further challenge the ability of object detection models and/or algorithms to localize and classify such objects depicted in one or more frames.

In certain aspects, object occlusion, small object size, and/or poor object visibility may occur for static objects depicted in a frame. As used herein, “static objects” may refer to objects in a scene that remain stationary and do not move over a period of time. Example static objects in a scene may include traffic elements. Effective object detection systems should account for the aforementioned challenges associated with static objects in a scene to allow for accurate object detection and thus robust environmental perception in autonomous intelligent systems.

Certain aspects described herein overcome the aforementioned technical problems associated with objection detection and provide a technical benefit to the field of computer vision. Specifically, certain aspects described herein provide techniques for constructing a dynamic global map (simply referred to herein as a “global map”), which may be leveraged for object detection by, for example, an autonomous vehicle.

For example, at least one static object in a dynamic, real-world scene may be depicted by one or more samples (e.g., pixels, points, etc.) in a first frame produced by a sensor associated with an autonomous vehicle. The samples associated with the static object may be ambiguous, such that the autonomous vehicle is unable to accurately identify and locate the static object in the first frame. Thus, according to aspects described herein, additional information for the static object may be obtained from the global map and used to supplement and/or enhance object detection of the static object in the scene, by the autonomous vehicle. In certain aspects, the additional information obtained for the static object comprises a second frame including the static object. The second frame may be generated based on the global map. The second frame may depict the static object with a level of detail that is greater than a level of detail associated with the static object and provided in the first frame. This additional detail may help the autonomous vehicle to more accurately detect the static object, thereby improving the vehicle's situational awareness and decision-making capabilities (e.g., such as to safely navigate the vehicle through the scene).

In certain aspects, the global map represents a visual representation of an environment that may be used for objection localization and classification. In certain aspects, the global map may represent one or more objects, such as static object(s), surrounding autonomous vehicle. In certain aspects, the global map is generated using techniques, such as three dimensional (3D) Gaussian splatting.

3D Gaussian splatting is an approach for creating and rendering 3D scenes using “Gaussian splats.” With this approach, a 3D scene may be represented with a collection of Gaussians, each encoded with attributes such as position, color, and opacity. For example, a point cloud may be generated for a 3D scene based on a 3D scanning process. Each “point” included in the point cloud may refer to a data point in a 3D coordinate system representing a single spatial measurement on an object's surface in the 3D scene. For example, each point may be expressed as a set of x, y, and z coordinates. Each respective point in the 3D point cloud may be represented by a respective 3D Gaussian kernel centered at the respective point's location . . . “Splatting” may be used to project each of these 3D Gaussian kernels to a 2D image plane during rendering (after which they may be referred to herein as “Gaussian splats”). The contribution of each 3D Gaussian kernel may be calculated based on its size, shape, and distance from a center point. In certain aspects, Gaussian splatting may be used to generate multiple sub-maps, where each sub-map includes multiple 3D Gaussian kernels associated with a single entity (e.g., associated with points from point clouds generated by sensor(s) located at or on a single entity). The sub-maps may be aligned and used to create the global map. Alignment of the sub-maps, and more specifically the 3D Gaussian kernels, such as to properly position and orient the different sub-maps, may be useful to accurately approximate a representation of the 3D scene. 3D Gaussian splatting may model a scene with fine detail and fidelity, accurately capturing not only the geometry of the scene, but also its lighting and/or reflections.

For example, 3D Gaussian splatting techniques may be used to represent a plurality of samples, from a plurality of frames generated by sensor(s) associated with a single entity (e.g., a single vehicle), as a plurality of 3D Gaussian kernels, which may be combined in a sub-map (e.g., via splatting) and associated with the single entity. Similar techniques may be used to also generate 3D Gaussian kernels and sub-map(s) for one or more other entities (e.g., one or more other vehicles). In certain aspects, the sub-maps associated with each of the entities may be aligned and combined in global map based on solving a non-linear optimization problem.

Certain techniques for static objection information retrieval described herein may provide various beneficial technical effects and/or advantages. The techniques for static objection information retrieval, utilizing a global map, may enable improved object detection of ambiguous static objects, including improving the accuracy and robustness of the detection. The improved object detection performance may be attributable to the use of more detailed, richer data for ambiguous static objects, which is obtained from the global map, when localizing and classifying ambiguous static objects in a scene. By providing more accurate and robust object localization and classification, autonomous intelligent systems may be able to better understand, interpret, and/or interact with the physical world.

### Example System for Static Object Information Retrieval and Detection

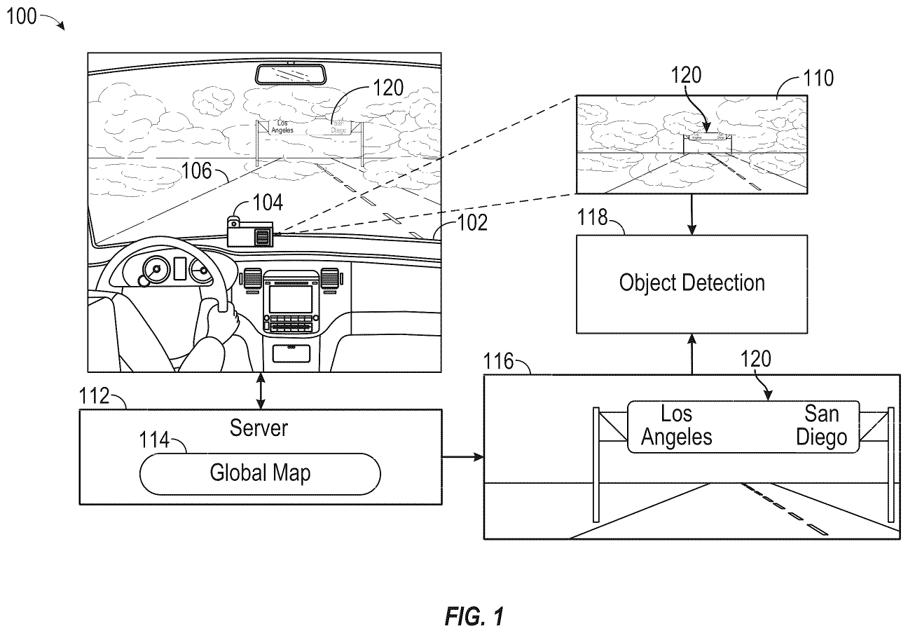

FIG. 1 depicts an example system 100 for static object information retrieval and detection. As shown, system 100 includes a vehicle 102 in communication with a server 112. In certain aspects, vehicle 102 may communicate with server 112 to obtain information for a static object represented in a frame generated by one or more sensors associated with (e.g., disposed on, mounted on, or included in any location of) vehicle 102, such as static object 120 represented in frame 110 (e.g., an image) generated by image sensors 104 associated with vehicle 102.

For example, vehicle 102 may be an (partially or fully) autonomous vehicle, where operation of vehicle 102 occurs without direct user input to control the steering, acceleration, and/or braking of vehicle 102. In certain aspects, vehicle 102 may be designed such that a user of the vehicle is not expected to constantly monitor a road 106, such as while the vehicle 102 is operating in the self-driving mode.

As shown in FIG. 1, vehicle 102 includes an image sensor 104 (e.g., camera, a stereographic camera, a depth sensing camera, etc.). Image sensor 104 may be configured to generate frames, such as two-dimensional (2D) images (e.g., which includes pixels in 2D space), for a scanned scene associated with vehicle 102. For example, image sensor 104 may be disposed, mounted, or included in any location of vehicle 102 suitable for capturing 2D images of a scene ahead, behind, or to the side of vehicle 102. In the example shown in FIG. 1, image sensor 104 is mounted on a dashboard of vehicle 102 to capture 2D images of a scene ahead of or in front of vehicle 102. In certain aspects, image sensor 104 may be adjusted or rotated in at least one direction in response to one or more control signals from an electronic device (not shown in FIG. 1) to adjust a pose, and thus a viewing angle, of image sensor 104.

“Pose” of image sensor 104 refers to the position and orientation of image sensor 104 in 3D space. The orientation of image sensor 104 may be represented as yaw, pitch, and roll angles. The pitch angle, yaw angle, and roll angle may represent an amount of image sensor 104 rotation of the image sensor 104 along an X-axis, Y-axis, and Z-axis, respectively, for example, with respect to a coordinate system of the image sensor. Pose of image sensor 104 may directly affect image sensor 104's viewing angle, which in turn determines how a scene (or object(s) in the scene) are perceived and captured by image sensor 104. Specifically, viewing angle of image sensor 104 may refer to the extent or range of a scene that image sensor 104 can capture, such as based on its position, orientation, and a focal length of a lens being used in image sensor 104. The viewing angle of image sensor 104 may determine how much of a scene is visible in a frame generated by image sensor 104 at any given time.

Further, as used herein “focal length” is an optical property of an optical lens, or system of lenses, which measures the distance, in millimeters (mm) between a nodal point of the lens and the image sensor 104. The “nodal point” may refer to the point where light converges in a lens. The focal length of image sensor 104 may directly determine a zoom level of image sensor 104. For example, a longer focal length may correspond to greater magnification, or the generation of a more zoomed-in-view (e.g., frame) by image sensor 104, while a shorter focal length may correspond to less magnification, or the generation of a less zoomed-in-view (e.g., frame) by image sensor 104 (e.g., resulting in a wider field of view).

Frames generated by image sensor 104 may include 2D frames or 2D representations, such as 2D images. In certain aspects, the frames may include one or more objects (as in depictions of one or more objects) in the scene associated with vehicle 102. That is, each frame may include samples (e.g., pixels) associated with one or more objects in the scene. The objects may include dynamic objects, such as pedestrians, cyclists, and/or the like, and/or static objects, such as traffic elements, road markings, and/or the like.

In certain aspects, at least one object in the frames produced by image sensor 104 comprises a “static object,” and more specifically an “ambiguous static object.” As described herein, an “ambiguous static object” may refer to a static object that can be interpreted in multiple ways by an objection detection system due to its visual appearance, thereby making it difficult localize and classify as a single specific object in the scene. One example ambiguous static object may include an object that is occluded (e.g., either partially or fully) by one or more other objects in the scene. Another example ambiguous object may include a small static object in a frame generated by image sensor 104, or more specifically, a static object associated with a small number of samples (e.g., pixels) in the frame. Another example ambiguous object may include an object with minimal visibility in a frame generated by image sensor 104. The minimal visibility of the static object may be due to adverse weather conditions existing when the frame was generated, poor lighting conditions existing when the frame was generated, minimal color differences and/or brightness variations between the static object and one or more other objects in the scene, and/or damage caused to the static object in the real-world scene, among other factors.

Although the image sensor 104 is depicted as a single image sensor in FIG. 1, in some other examples, the vehicle 102 may include any suitable number of image sensors. For example, two or more image sensors may be disposed, mounted, or included in any location of vehicle 102 and used to generate one or more frames for a scene associated with vehicle 102. Further, although FIG. 1 depicts vehicle 102 including only an image sensor 104, in some other examples, vehicle 102 may include one or more other types of sensors, such as LiDAR(s), RADAR(s), etc. for perceiving the scene associated with vehicle 102. Frames produced by these other types of sensors may include 2D or 3D frames (e.g., such as 3D point clouds) comprising samples (e.g., pixels, points, measurements, etc.) associated with objects in a scene surrounding vehicle 102. In certain aspects, frames may be produced by combining/fusing data from multiple sensors associated with vehicle 102.

In certain aspects, such as shown in the example depicted in FIG. 1, frames generated by image sensor 104 may include a frame 110. For example, while traveling on road 106, such as heading towards a static object 120, image sensor 104 may capture at least one frame 110 of the road 106 including the static object 120, which is within a viewing angle of the image sensor 104. In this example, the static object 120 may comprise a traffic element. The term “traffic element” may refer to any element that includes or indicates information, an instruction, or a warning for driving a vehicle and may indicate status, a condition, a direction, or the like that relates to a road or vehicle traffic. The static object 120 in this example comprises a sign indicating that the direction vehicle 102 is traveling is heading south towards Los Angeles and San Diego, California. Due to foggy weather conditions, as well as the focal point of the image sensor 104, static object 120 depicted in frame 110 may be blurry. The poor object visibility of static object 120 in frame 110, in combination with the small size of static object 120, may classify static object 120 as an example ambiguous static object in frame 110.

Vehicle 102 may perform object detection 118 based on frames generated by image sensor 104, such as frame 110. In certain aspects, objection detection 118 may include performing 3D object detection to detect one or more 3D objects in the frame(s) as a plurality of detections. In certain aspects, objection detection 118 may include performing 2D object detection to detect one or more 2D objects in the frames as a plurality of detections. A detection may refer to the identification and localization of an object or object state(s) within a given frame. This identification can be represented by various data types, such as by bounding boxes, points, or clusters, depending on the sensor modality and the specific application. Thus, a detection may be a flexible concept that applies to various sensor modalities and data representations.

As an illustrative example, where the frames include 2D images (e.g., such as frame 110), a detection may be represented by a bounding box that encloses a detected object (e.g., a car, pedestrian, static object, etc.). The bounding box may be defined by its coordinates, which specify the object's position within the image.

In certain aspects, object(s) in the frames, such as frame 110, may be identified using one or more object detection models applied to the frames. Such models may analyze visual and depth information to locate and classify objects within the scene captured by the frames as the plurality of detections. Example object detection models may include BEVFusion, BEVDET, and LargeKernel3D, to name a few.

In certain aspects, vehicle 102 may struggle to accurately detect, locate, and classify (e.g., during object detection 118) static object 120 in frame 110, at least due to the small object size and poor object visibility of static object 120 in frame 110. Thus, to allow for more robust object detection by vehicle 102, certain aspects described herein enable vehicle 102 to communicate with a server 112 to obtain additional information associated with static object 120. More specifically, vehicle 102 may communicate with server 112 to obtain a frame 116 that represents static object 120 in the scene in a more discernable fashion (such as free of occlusion, in higher resolution, etc.). Frame 110, from image sensor 104, may represent static object 120 with a first level of detail, while the frame 116, from server 112, may represent static object 120 with a second level of detail that is greater than the first level of detail.

For example, using the example depicted in FIG. 1, frame 116 may provide a more zoomed-in view of static object 120 than frame 110. In certain aspects, the more zoomed-in view may include more samples (e.g., pixels) associated with static object 120, which may be used by an object detection model and/or algorithm for more accurate detection and/or classification of static object 120. Further, frame 116 may more clearly depict static object 120 in the scene than frame 110, for example, removing the distortion resulting from the fog in frame 110.

In certain aspects, frame 116 may be generated based on a global map 114 stored at server 112. Global map 114 may represent a map of an environment that may be used for objection localization and classification. In certain aspects, global map 114 may represent one or more objects, such as static object(s), surrounding vehicle 102, such as at a time when frame 110 is generated by image sensor 104. In certain aspects, global map 114 is generated using techniques such as 3D Gaussian splatting. For example, 3D Gaussian splatting techniques may be used to represent a plurality of samples, from a plurality of frames generated by sensor(s) associated with a single entity (e.g., a single vehicle), as a plurality of 3D Gaussian kernels, which may be combined in a sub-map (e.g., using splatting) and associated with the single entity. Similar techniques may be used to generate one or more other 3D Gaussian kernels and sub-map(s) for one or more other entities (e.g., one or more other vehicles). The sub-maps associated with each of the entities may be aligned and combined to create global map 114, such as based on solving a non-linear optimization problem. In certain aspects, solving the non-linear optimization problem may involve minimizing a loss function that quantifies the difference between a combined set and an original set of Gaussian kernels from one or more scenes. Initial estimates may be derived based on placing the local sub-maps (e.g., Gaussian kernels) in a world coordinate system and then applying iterative enhancement through the non-linear optimization to help enhance accuracy.

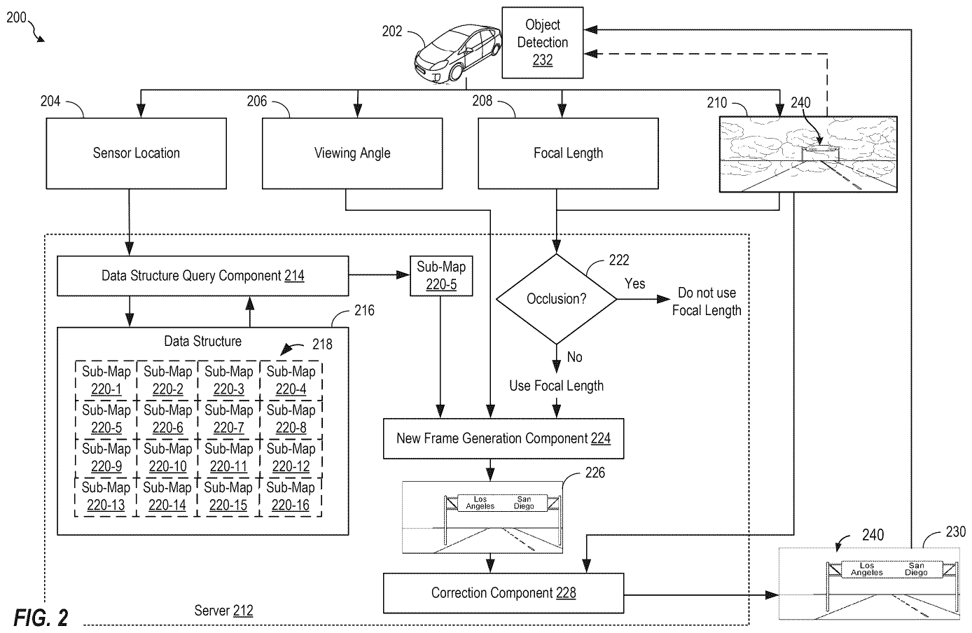

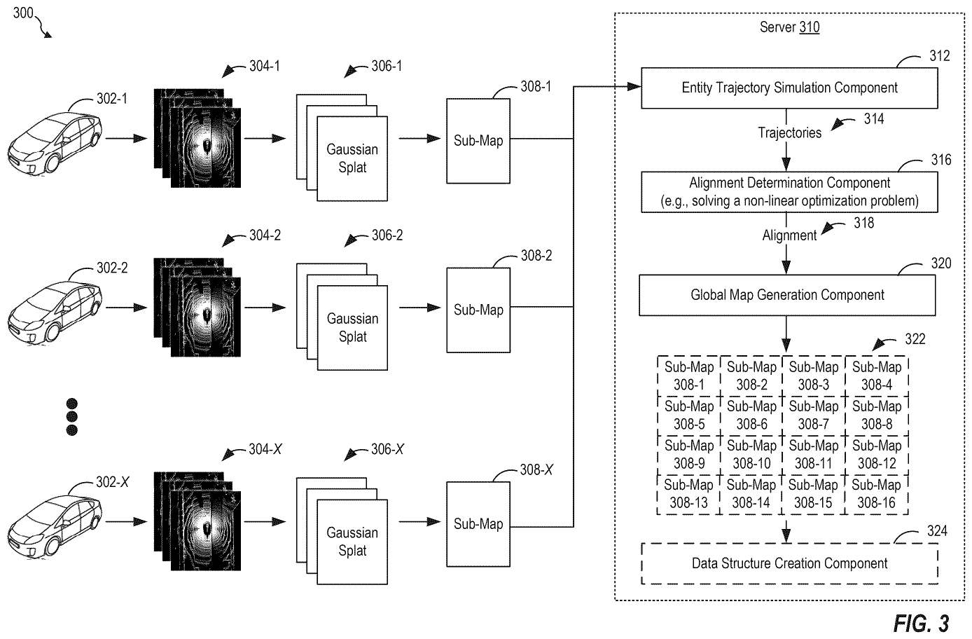

Additional details related to static object information retrieval, such as to obtain additional information for static object 120 in FIG. 1, are provided below with respect to FIG. 2. Further, additional details related to global map generation, such as to generate global map 114 in FIG. 1, are provided below with respect to FIG. 3.

### Aspects Related to Static Objection Information Retrieval Using a Dynamic Global Map

FIG. 2 depicts an example workflow 200 for static object information retrieval using a dynamic global map. In certain aspects, workflow 200 may be used to obtain additional information about an ambiguous static object, such as static object 240 shown in FIG. 2.

Workflow 200 begins with vehicle 202 generating frame 210 (e.g., image I_{car}) representing one or more static objects in a scene during a first time period. In certain aspects, the static object(s) represented in frame 210 (I_{car}) include static object 240. Similar to FIG. 1, in example workflow 200, static object 240 may comprise a traffic element, and more specifically, a sign indicating a direction towards Los Angeles and San Diego, California. Static object 240 may represent an ambiguous static object at least due to its small object size and power object visibility in frame 210 (I_{car}).

Frame 210 (I_{car}) may be captured by a sensor associated with vehicle 202, such as an image sensor, a LiDAR sensor, or an inertial measurement unit (IMU) sensor. The sensor may be located at a sensor location 204 when frame 210 (I_{car}) is generated by the sensor. In certain aspects, sensor location 204 may comprise a coarse location (l=(x, y, z)) of vehicle 202. Further, the sensor may capture frame 210 (I_{car}) with a viewing angle 206 (θ=(φ, ψ)) and a focal length 208.

Workflow 200 then proceeds with a data structure query component 214 of a server 212 obtaining information about the sensor location 204 of vehicle 202. Data structure query component 214 may use sensor location 204 (e.g., the coarse location, l=(x, y, z) of vehicle 202) to query a data structure 214. Data structure 216 may be a data structure associated with a global map 218 comprising a plurality of sub-maps 220-1 through 220-16 (individually referred to herein as “sub-map 220” and collectively referred to herein as “sub-maps 220”) representing the scene surrounding vehicle 202 for the first time period. In this example, data structure query component 214 may identify a sub-map 220-5, among the sub-maps 220 included in global map 218, based on querying data structure 216. Sub-map 220-5 may include information about at least static object 240.

In certain aspects, sub-map 220-5 may comprise a sub-map closest in distance to sensor location 204. For example, when querying data structure 216, a respective distance between sensor location 204 and a respective centroid of each sub-map 220 of the sub-maps 220 included in global map may be determined. In this regard, sub-map 220-5 may be identified (e.g., selected) based on the distance between the centroid of sub-map 220-5 and sensor location 204 being the smallest distance among the determined distances. For example, the sub-map selection may be formulated as:

$${M}_{s e l e c t e d} = arg \begin{matrix}min \\ {M}_{i} ∈ {M}_{g}\end{matrix} ‖ l - c ( {M}_{i} ) ‖$$

where M_{selected} represents the selected sub-map 220-5, M_{g}={M₁, M₂, . . . , M_{K}} represents the sub-maps 220 included in global map 218, Mᵢ represents a single sub-map 220 included in global map 218, and c(Mᵢ) represents a centroid of sub-map 220 Mᵢ.

In certain aspects, to beneficially reduce graphics processing unit (GPU) memory usage and/or facilitate rapid spatial queries, data structure 216 may be used to efficiently organize information in global map 218. In certain aspects, data structure 216 comprises a K-Dimensional (KD) tree, which is a binary search tree where data in each node is a K-Dimensional point in space. Put differently, a KD tree is a space partitioning data structure, which may be used for organizing points in a K-Dimensional space.

Workflow 200 then proceeds with a new frame generation component 224 of server 212 generating a frame 226 (e.g., image Iₙₒᵥₑₗ). In certain aspects, frame 226 (Iₙₒᵥₑₗ) may be generated by new frame generation component 224 based on sub-map 220-5 (e.g., selected based on sensor location 204 (coarse location l)) and viewing angle 206 (θ) (e.g., of the sensor that produced frame 210). For example, frame 226 (Iₙₒᵥₑₗ) may be a novel view for viewing angle 206 (θ), which is associated with sensor location 204 (coarse location l)).

In certain aspects, frame 226 (Iₙₒᵥₑₗ) may be generated by new frame generation component 224 further based on focal length 208. In particular, as shown in the example in FIG. 2, when static object 240 is determined not to be occluded in frame 210 by one or more other objects (e.g., such as a traffic sign, overgrowth of a tree, etc.), frame 226 (Iₙₒᵥₑₗ) may be generated based on focal length 208. For example:

$${I}_{n o v e l} = Render ( {M}_{s elected} , l , θ , f )$$

where f is the focal length used to generate frame 226 (Iₙₒᵥₑₗ). In certain aspects, the focal length f used to generate frame 226 (Iₙₒᵥₑₗ) is determined based on focal length 208, such that the focal length f used to generate frame 226 (Iₙₒᵥₑₗ) is different than focal length 208. That is, the focal length f used to generate frame 226 (Iₙₒᵥₑₗ) may be larger than focal length 208 such that frame 226 (Iₙₒᵥₑₗ) provides a more zoomed-in view of static object 240 than frame 210 (I_{car}) (e.g., as shown in FIG. 2). Frame 226 (Iₙₒᵥₑₗ) may be in the general viewing direction (e.g., viewing angle 206 (θ)) of vehicle 202.

In certain other aspects, as shown in the example in FIG. 2, when static object 240 is determined to be occluded in frame 210 by one or more other objects, frame 226 (Iₙₒᵥₑₗ) may not be generated based on focal length 208. Instead, frame 226 may be generated from a location where static object 240 is clearly visible. For instance, if static object 240 is 100 meters away from vehicle 202, frame 226 (Iₙₒᵥₑₗ) may not be generated from sensor location 204 (coarse location ( ), but instead from a point where static object 240 is properly visible.

It is noted that FIG. 2 is only one example, and focal length 208 may or may not be used for when there is occlusion or when there is no occlusion. For example, in certain aspects, frame 226 (Iₙₒᵥₑₗ) may be generated based on focal length 208 when static object 240 is (1) determined to be occluded in frame 210 by one or more other objects (e.g., such as a traffic sign, overgrowth of a tree, etc.) or (2) determined not to be occluded in frame 210. In certain aspects, frame 226 (Iₙₒᵥₑₗ) may not be generated based on focal length 208 when static object 240 is (1) determined to be occluded in frame 210 by one or more other objects (e.g., such as a traffic sign, overgrowth of a tree, etc.) or (2) determined not to be occluded in frame 210. In either case, when static object 240 is occluded, the frame 226 (Iₙₒᵥₑₗ) may be generated based on information included in sub-map 220-5 of the global map 215 (e.g., information about the static object 240 when it was not occluded). For example, static object 240 may comprise a traffic sign that is occluded by a moving bus. In this example, frame 226 (Iₙₒᵥₑₗ) may be generated based on information included in sub-map 220-5 to generate a view of the traffic sign that is not occluded by the moving bus (e.g., the information included in sub-map 220-5 may include information about the traffic sign when it was not previously occluded).

Workflow 200 then proceeds with a correction component 228 of server 212 generating a frame 230 (e.g., image I_{aligned}). Frame 230 (I_{aligned}) may represent an alignment of frame 226 (Iₙₒᵥₑₗ) with frame 210 (I car), such as to correct the view of frame 230 (I_{aligned}) to the real viewing angle of the sensor that captured frame 210 (I_{car}). In certain aspects, the real viewing angle of the sensor may be different than viewing angle 206. For example, the sensor may be mounted on vehicle 202 to operate with viewing angle 206; however, due to one or more external factors, such as vehicle 202 driving over a speed bump, the mount of the sensor breaking, etc., the real viewing angle of the sensor may be different than viewing angle 206. Correction component 228 may be used to generate frame 230 (I_{aligned}) to account for this difference.

In certain aspects, to generate frame 230 (I_{aligned}), correction component 228 (1) generates a homography matrix (H) indicating a correspondence between samples included in frame 210 (I_{car}) and samples included in frame 226 (Iₙₒᵥₑₗ) and (2) generates frame 230 (I_{aligned}) based on frame 210 (I_{car}) and the homography matrix (H). For example:

$${I}_{n o v e l} ( {x}^{′} , {y}^{′} ) = {I}_{c a r} ( x , y )$$

$$where$$

$${( {x}^{′} , {y}^{′} )}^{T} = {H ( x , y , 1 )}^{T}$$

$$and$$

$$H = arg \begin{matrix}min \\ H\end{matrix} {\sum }_{( p , {p}^{′} )} {‖ {p}^{′} - Hp ‖}^{2}$$

where (p, p′) corresponds to samples in frame 210 (I_{car}) and frame 226 (Iₙₒᵥₑₗ). In certain aspects, the samples in frame 210 (I_{car}) and/or frame 226 (Iₙₒᵥₑₗ) comprise points in a point cloud(s). In certain aspects, the samples in frame 210 (I_{car}) and/or frame 226 (Iₙₒᵥₑₗ) comprise points in an image(s). In certain aspects, the homography matrix (H) may be generated based on feature matching and a random sample consensus (RANSAC) algorithm. RANSAC is an iterative method used to estimate parameters of a mathematical model from a set of observed data that contains outliers. RANSAC may be particularly useful when dealing with noisy and/or contaminated data.

Frame 230 (I_{aligned}) may provide additional context for static object 240 than frame 210 (I_{car}). That is, frame 210 (I_{car}) may represent static object 240 with a first level of detail, while frame 230 (I_{aligned}) may represent static object 240 with a second level of detail that is greater than the first level of detail.

Workflow 200 then proceeds with vehicle 202 receiving frame 230 (I_{aligned}). In certain aspects, vehicle 202 may use frame 230 (I_{aligned}) (and additionally, in some cases, frame 210 (I_{car})) for object detection 232. Use of frame 230 (I_{aligned}) may allow for more robust object detection 232. For example, localization and classification of static object 240 may be less challenging when using frame 230 (I_{aligned}) as an alternative to using frame 210 (I_{car}) (or in addition to using frame 210 (I_{car}) for object detection 232.

While a client-server architecture may be used to perform workflow 200 shown in FIG. 2, in certain other aspects, other architecture may be considered. For example, in some cases, steps of workflow 200 may be performed locally.

### Aspects Related to Global Map Creation

FIG. 3 depicts an example workflow 300 for global map creation. In certain aspects, workflow 300 may be used to generate a global map 322 shown in FIG. 3 (and/or global map 114 shown in FIG. 1 and/or global map 218 shown in FIG. 2.

Workflow 300 begins with obtaining multiple frames 304-1 through 304-X (collectively referred to herein as “frames 304” and individually referred to herein as “frame 304”) associated with multiple entities, such as vehicles 302-1 through 302-X (collectively referred to herein as “vehicle 302” and individually referred to herein as “vehicle 302”). For example, sensor(s) disposed, mounted, and/or included in any location of a first vehicle 302-1 may generate frames 304-1, sensor(s) disposed, mounted, and/or included in any location of a second vehicle 302-2 may generate frames 304-2, etc. Example sensor(s) used to produce frames 304 may include LiDAR sensors, image sensor, IMU sensors, and/or the like. In certain aspects, the sensors disposed, mounted, and/or included in any of the locations of first vehicle 302-1 and second vehicle 302-2 include image sensors (e.g., cameras).

Each frame 304 may include a plurality of samples associated with at least a plurality of static objects in a scene. In certain aspects, the samples include points associated with multiple point clouds (e.g., example frames 304, where the sensor(s) include LiDAR sensor(s)). Pᵢ={(xⱼ, yⱼ, zⱼ)|j=1, 2, . . . , n} may represent the point clouds generated by LiDAR sensor(s)) associated with a vehicle 302 i. In certain aspects, the samples include pixels associated with multiple images (e.g., example frames 304, where the sensor(s) include images sensor(s)).

$${I}_{i} = \{ {I}_{i}^{t} \vert t = 1 , 2 , … , T \}$$

may represent the images generated by image sensor(s) associated with a vehicle 302 i. In certain aspects, the samples include lists of time periods associated with accelerometer and/or gyroscope values (e.g., where the sensor(s) include IMU sensor(s)).

In workflow 300, samples from frames 304 generated by sensor(s) associated with a vehicle 302 may be represented as multiple 3D Gaussian kernels rendered in a 2D image plane, also referred to herein as Gaussian splats (e.g., shown as Gaussian splats 306-1 through 306-X in FIG. 3, which may be collectively referred to herein as “Gaussian splats 306” and/or individually referred to herein as “Gaussian splat 306”). For example, in certain aspects, each sample in a frame 304 may be converted into a Gaussian splat 306. Gaussian splats 306 generated for samples associated with sensor(s) of a vehicle 302 may be used to generate a sub-map (e.g., shown as sub-maps 308-1 through 308-X in FIG. 3, which may be collectively referred to herein as “sub-maps 308” and/or individually referred to herein as “sub-map 308”). For example, a first sub-map 308-1 may be generated based on Gaussian splats 306-1 associated with vehicle 302-1, a second sub-map 308-2 may be generated based on Gaussian splats 306-2 associated with vehicle 302-2, etc.

The X sub-maps 308 generated in workflow 300 may include:

$${M}_{g} = \{ {M}_{1} , {M}_{2} , … , {M}_{X} \}$$

where {M₁, M₂, . . . , M_{X}} represents the individual sub-maps 308. A single sub-map (Mᵢ) may be represented as:

$${M}_{i} = \{ {G}_{1} , {G}_{2} , … , {G}_{Z} \}$$

where {G₁, G₂, . . . , G_{Z}} represents the individual Gaussian splats 306 that make up sub-map (Mᵢ). Sub-map (Mᵢ) may represent areas that a vehicle i has driven through. For example sub-map (Mᵢ) may be represented as:

$${M}_{i} = GaussianSplat ( {P}_{i} , {I}_{i} , {T}_{i} )$$

$$where$$

$${P}_{i} = \{ ( {x}_{j} , {y}_{j} , {z}_{j} ) \vert j = 1 , 2 , … , n \}$$

and represents the point clouds generated by LiDAR sensor(s)) associated with a vehicle i,

$${I}_{i} = \{ {I}_{i}^{t} \vert t = 1 , 2 , … , T \}$$

and represents the images generated by image sensor(s) associated with a vehicle i, and

$${T}_{i} ( t ) = [ \begin{matrix}{R}_{i} ( t ) & {t}_{i} ( t ) \\ 0 & 1\end{matrix} ]$$

and represents the pose of vehicle i (e.g., Rᵢ(t) represents the rotation/orientation of vehicle i and tᵢ(t) represent the translation/location of vehicle i).

Each Gaussian splat (Gⱼ) in sub-map (Mᵢ) may be represented as:

$${G}_{j} = ( {u}_{j} , {\sum }_{j} , {a}_{j} )$$

where μᵢεR³ represents the mean position, Σⱼ∈R^{3×3} represents the covariance matrix, and aⱼ represents the opacity associated with Gaussian splat (Gⱼ).

In certain aspects, the frames 304 comprise samples representing static objects and one or more dynamic objects in a scene. Thus, in certain aspects, prior to generating Gaussian splats 306 and sub-maps 308, dynamic objects may be removed from the frames 304. For example, at least one sample associated with a dynamic object in the scene, and depicted in a frame 304, may be identified and removed from the frame 304. Further, inpainting techniques may be used to inpaint a location in the frame 304 associated with the sample that was removed. As used herein, inpainting is a technique of filling in missing parts and/or regions of a frame (e.g., an image).

Each of the sub-maps 308 (Mᵢ) may be provided to a server 310 for global map 322 generation (e.g., first sub-map 308-1 may be sent to server 310 from vehicle 302-1, second sub-map 308-2 may be sent to server 310 from vehicle 302-2, etc.). For example, server 310 may be configured to integrate each of sub-maps 308 in global map 322.

To generate global map 322, workflow 300 may proceed with an entity trajectory simulation component 312 of server 310 simulating a plurality of trajectories 314 for vehicles 302. For example, for each vehicle 302, entity trajectory simulation component 312 may simulate a respective plurality of trajectories 314, for the specific vehicle 302, from the sub-map 308 associated with the vehicle 302 to one or more other sub-maps 308 generated in workflow 300. Thus, a first plurality of trajectories 314 may be simulated for first vehicle 302-1, a second plurality of trajectories 314 may be simulated for second vehicle 302-2, etc. The trajectories 314 simulated for a vehicle i may be represented as:

$${T}_{i} = \{ {T}_{1} , {T}_{2} , … , {T}_{N} \}$$

where {T₁, T₂, . . . , T_{N}} represents the plurality of trajectories 314 created from sub-map 308 Mᵢ to neighboring sub-maps 308. Each trajectory Tᵢ may comprise a sequence of poses represented as:

$${T}_{j} = \{ {P}_{i}^{1} , {P}_{i}^{2} , … , {P}_{i}^{L} \}$$

$$where {P}_{i}^{t} = [ {R}_{i}^{t} \vert {t}_{i}^{t} ] ∈ S E ( 3 )$$

represents the pose at time t.

Workflow 300 then proceeds with an alignment determination component 316 of server 310 determining an alignment 318 for the plurality of sub-maps 308, in global map 322. In certain aspects, alignment determination component 316 may determine the alignment 318 based on solving a non-linear optimization problem used to reduce a re-projection error across the plurality of trajectories 314. For example, in certain aspects, the non-linear optimization problem may be represented as:

$${min}_{θ} {\sum }_{i = 1}^{N} {\sum }_{t = 1}^{T} {\sum }_{j = 1}^{M} {‖ π ( {P}_{i}^{t} {G}_{j} ) - {z}_{i}^{t , j} ‖}^{2}$$

where θ represents the parameters to be optimized (e.g., the pose

$${P}_{i}^{t}$$

(M_{g}={M₁, M₂, . . . , M_{X}}), π(·) represents a projection function, and

$${z}_{i}^{t , j}$$

observed projection of Gaussian splat 306 (Gⱼ) in trajectory 314 (Tⱼ) at time t. In certain aspects, the solution to this non-linear optimization problem may yield optimal alignment of the sub-map 308 (Mᵢ) (e.g., as part of alignment 318) in global map 322.

Workflow 300 then proceeds with a global map generation component 320 of server 310 generating the global map 322, comprising the plurality of sub-maps 308, based on the alignment 318.

In some cases, workflow 300 may optionally proceed with a data structure creation component 324 creating a data structure used to organize information in global map 322. In certain aspects, the data structures comprises a KD tree.

In certain aspects, after the generation of global map 322, global map 322 may be dynamically updated in a federated learning fashion. Federated learning is a decentralized approach to training ML models. Federated learning may not require an exchange of data from edge devices to a centralized server. Instead, the raw data on edge devices may be used to train the model locally, increasing data privacy. A final model may be formed in a shared manner by aggregating local updates from the edge devices.

According to aspects described herein, aggregated changes from various entities (e.g., vehicles) may be used to update the globally stored sub-maps (e.g., in the global map maintained at the server) using federated learning. For example, a vehicle i may store a local copy of a sub-map generated based on data from sensor(s) of vehicle i. The local copy of the sub-map stored at vehicle i may comprise a set of 3D Gaussian kernels, the parameters of which are obtained using an ML model. Over time, sensor(s) associated with the vehicle i may generate additional frames representing object(s) in the scene, which may be used to update the locally stored sub-map associated with vehicle i. Specifically, the ML model may be trained using the additional frames. Training the ML model using the additional frames may update one or more weights of the ML model used to determine parameters of the locally stored sub-map. In certain aspects, the updates to one or more weights associated with the ML model are provided to the server to update the global map accordingly, and more specifically update the sub-map of the global map associated with vehicle i, instead of sending the new frames and updated local sub-map to server.

For each update from a vehicle i:

$${M}_{g}^{t + 1} = Federated Update ( {M}_{g}^{t} , {M}_{i}^{loal} )$$

$$where {M}_{i}^{local}$$

represents the locally updated sub-map associated with (e.g., from) vehicle i.

In certain aspects, federated learning techniques described herein may include mechanisms for handling data aging and conflict resolution. Data aging may occur due to various factors, such as changes in the underlying distribution of data, periodic patterns of data, etc. In certain aspects, implementing forgetting (e.g., discarding) and/or weighting (e.g., decreasing weighting) of older data may be used as an example mechanism for handling data aging. In certain aspects, regular updates to the data may be used as an example mechanism for handling data aging.

In certain aspects, the federated update may be implemented as:

$${M}_{g}^{t + 1} = {M}_{g}^{t} + η {\sum }_{i = 1}^{N} {w}_{i} ( {M}_{i}^{l o c a l} - {M}_{g}^{t} )$$

where η represents a learning rate, wᵢ represents a weight assigned to the update from a vehicle 302 i, and N represents a number of vehicles 302 contributing to the update.

For temporal data management, a time decay function may be represented as:

$$Releavance ( e , t ) = {e}^{- λ ( t - {t}_{e} )}$$

where e represents an ambiguous static object, t represents a current time, the represents a time when e was last updated, and A represents a decay rate. A “time decay function” may refer to a mathematical formula used to gradually reduce the weight and/or importance of older data over time, thereby assuming that recent data is generally more relevant than older data.

### Example Method for Static Object Information Generation

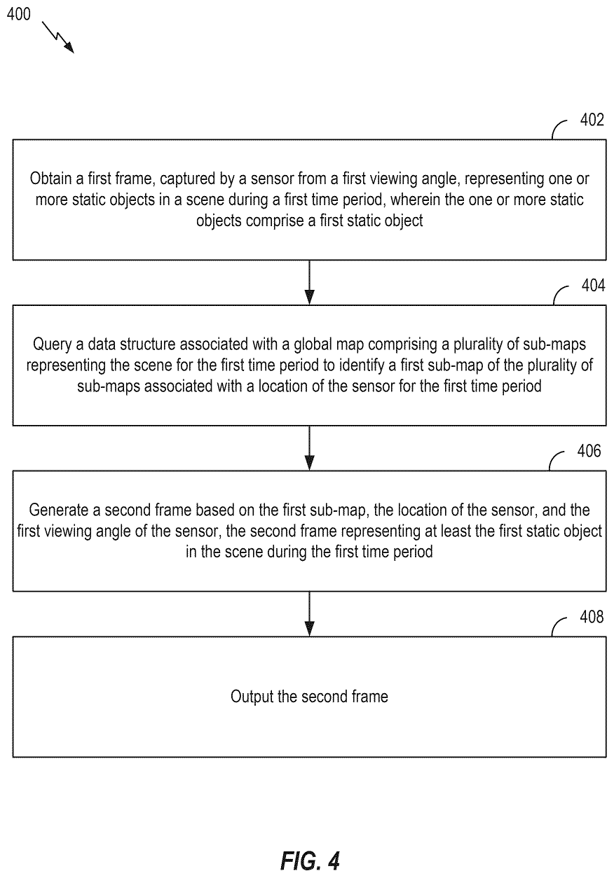

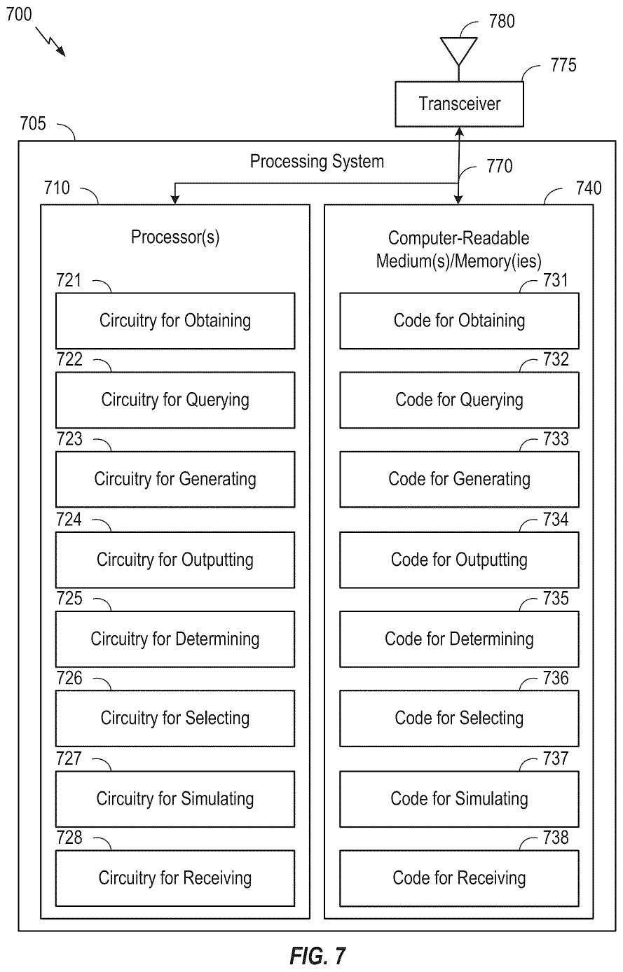

FIG. 4 depicts an example method 400 for static object information generation. In certain aspects, method 400, or any aspect related to it, may be performed by an apparatus, such as apparatus 700 of FIG. 7, which includes various components operable, configured, or adapted to perform the method 400.

Method 400 begins, at block 402, with obtaining a first frame, captured by a sensor from a first viewing angle, representing one or more static objects in a scene during a first time period. In certain aspects, the one or more static objects comprise a first static object.

Method 400 proceeds, at block 404, with querying a data structure associated with a global map comprising a plurality of sub-maps representing the scene for the first time period to identify a first sub-map of the plurality of sub-maps associated with a location of the sensor for the first time period.

Method 400 proceeds, at block 406, with generating a second frame based on the first sub-map, the location of the sensor, and the first viewing angle of the sensor, the second frame representing at least the first static object in the scene during the first time period.

Method 400 proceeds, at block 406, with outputting the second frame.

In certain aspects, the second frame is configured for use for object detection of at least the first static object in the scene.

In certain aspects, the first frame represents the first static object with a first level of detail; and the second frame represents the first static object with a second level of detail that is greater than the first level of detail.

In certain aspects, the first frame is associated with a first focal length; and the second frame is associated with a second focal length that is greater than the first focal length.

In certain aspects, querying the data structure to identify the first sub-map comprises: determining a respective distance between the location of the sensor and a respective centroid of each sub-map of the plurality of sub-maps to generate a plurality of distances; and selecting the first sub-map based on the respective distance between the location of the sensor and the respective centroid of the first sub-map being a smallest distance among the plurality of distances.

In certain aspects, the first frame comprises a first set of points; and generating the second frame comprises: generating a third frame based on the first sub-map, the location of the sensor, and the first viewing angle of the sensor, the third frame comprising a second set of points; generating a homography matrix indicating a correspondence between the first set of points of the first frame and the second set of points of the third frame; and generating the second frame based on the first frame and the homography matrix.

In certain aspects, generating the homography matrix comprises: generating the homography matrix based on feature matching and a RANSAC algorithm.

In certain aspects, method 400 further includes: obtaining the plurality of sub-maps, wherein each respective sub-map of the plurality of sub-maps is associated with a respective entity of a plurality of entities; simulating a plurality of trajectories for the plurality of entities based on, for each respective entity: simulating a respective plurality of trajectories for the respective entity from the respective sub-map associated with the respective entity to each other sub-map of the plurality of sub-maps; and determining an alignment for the plurality of sub-maps based on solving a non-linear optimization problem to reduce a re-projection error across the plurality of trajectories; and generating the global map comprising the plurality of sub-maps based on the alignment.

In certain aspects, the plurality of sub-maps comprise a plurality of 3D Gaussian splats; and the method further comprises receiving one or more updates to one or more weights associated with one or more 3D Gaussian splats of the plurality of 3D Gaussian splats.

In certain aspects, the first static object comprises a traffic element.

Method 400 provides a technical solution to detecting and classifying ambiguous static objects. For example, the improved object detection and classification performance may be attributable to the generation of the second frame, which provides more detailed, richer data for detection and classification of the first static object.

Note that FIG. 4 is just one example of a method, and other methods including fewer, additional, or alternative steps are possible consistent with this disclosure.

### Example Method for Object Detection

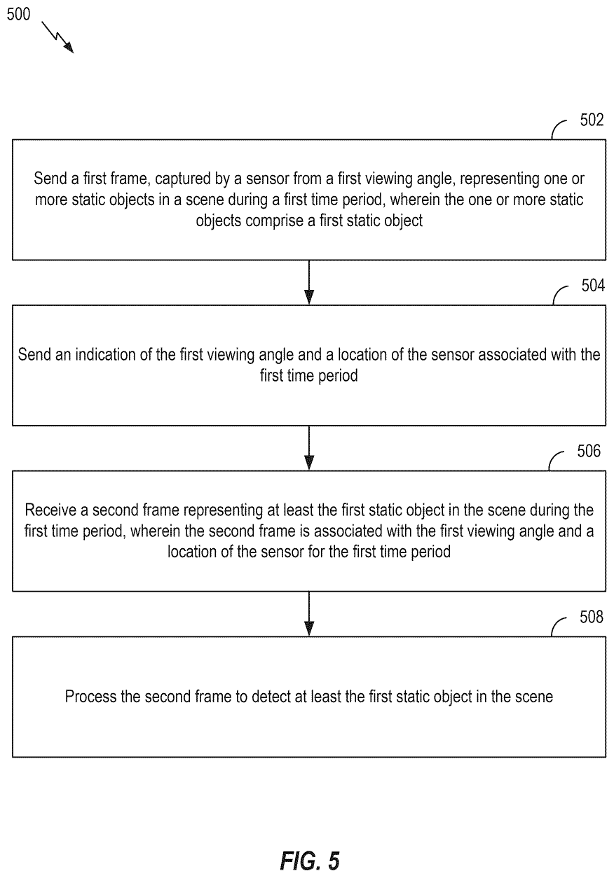

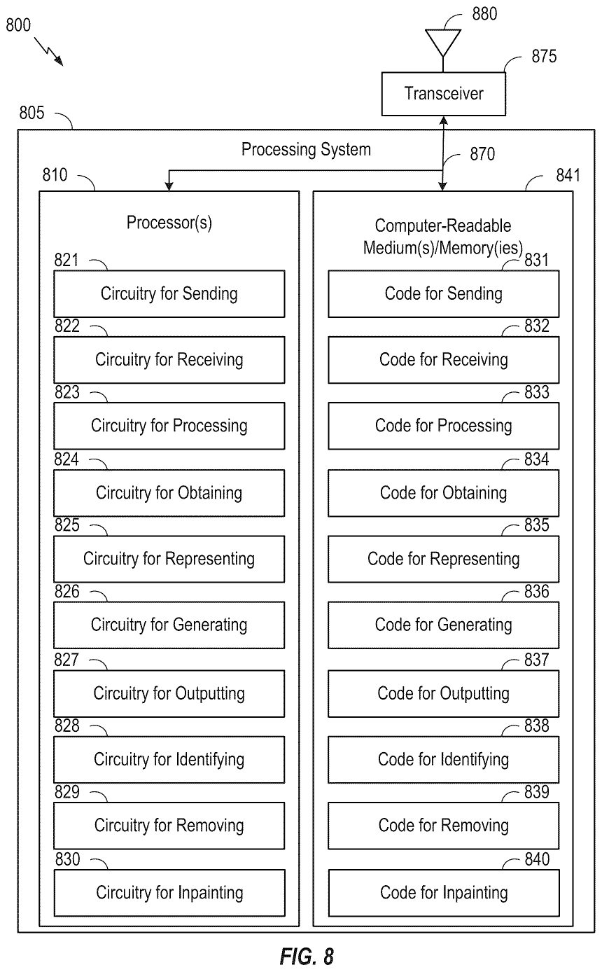

FIG. 5 depicts an example method 500 for object detection. In certain aspects, method 500, or any aspect related to it, may be performed by an apparatus, such as apparatus 800 of FIG. 8, which includes various components operable, configured, or adapted to perform the method 500.

Method 500 begins, at block 502, with sending a first frame, captured by a sensor from a first viewing angle, representing one or more static objects in a scene during a first time period. In certain aspects, the one or more static objects comprise a first static object.

Method 500 proceeds, at block 504, with sending an indication of the first viewing angle and a location of the sensor associated with the first time period.

Method 500 proceeds, at block 506, with receiving a second frame representing at least the first static object in the scene during the first time period, wherein the second frame is associated with the first viewing angle and a location of the sensor for the first time period.

Method 500 proceeds, at block 508, with and processing the second frame to detect at least the first static object in the scene.

In certain aspects, method 500 further includes obtaining a plurality of frames captured by one or more sensors, wherein the plurality of frames comprise a plurality of samples representing at least a plurality of static objects in the scene; representing the plurality of samples as a plurality of 3D Gaussian splats; generating a sub-map comprising the plurality of 3D Gaussian splats; and outputting the sub-map.

In certain aspects, the plurality of frames comprise the plurality of samples representing the plurality of static objects and one or more dynamic objects in the scene; and the method further comprises: identifying at least one sample of the plurality of samples associated with the one or more dynamic objects in the scene; removing the at least one sample from the plurality of frames; and inpainting at least one location in the plurality of frames associated with the at least one sample removed from the plurality of frames.

In certain aspects, the plurality of samples comprise at least one of: a plurality of points associated with a plurality of point clouds; a plurality of pixels associated with a plurality of images; a plurality of accelerometer values associated with a first plurality of time periods; or a plurality of gyroscope values associated with a second plurality of time periods.

In certain aspects, method 500 further includes sending one or more updates to one or more weights associated with one or more 3D Gaussian splats of the plurality of 3D Gaussian splats of the sub-map.

In certain aspects, the first frame represents the first static object with a first level of detail; and the second frame represents the first static object with a second level of detail that is greater than the first level of detail.

In certain aspects, the first frame is associated with a first focal length; and the second frame is associated with a second focal length that is greater than the first focal length.

In certain aspects, the first static object comprises a traffic element.

Method 500 provides a technical solution to detecting and classifying ambiguous static objects. For example, the improved object detection and classification performance may be attributable to retrieval of the second frame by the apparatus. For example, the apparatus may use more detailed, richer data associated with the first static object, and included in the second frame, to more accurately detect and classify the first static object.

Note that FIG. 5 is just one example of a method, and other methods including fewer, additional, or alternative steps are possible consistent with this disclosure.

### Example Sensor and Computing System

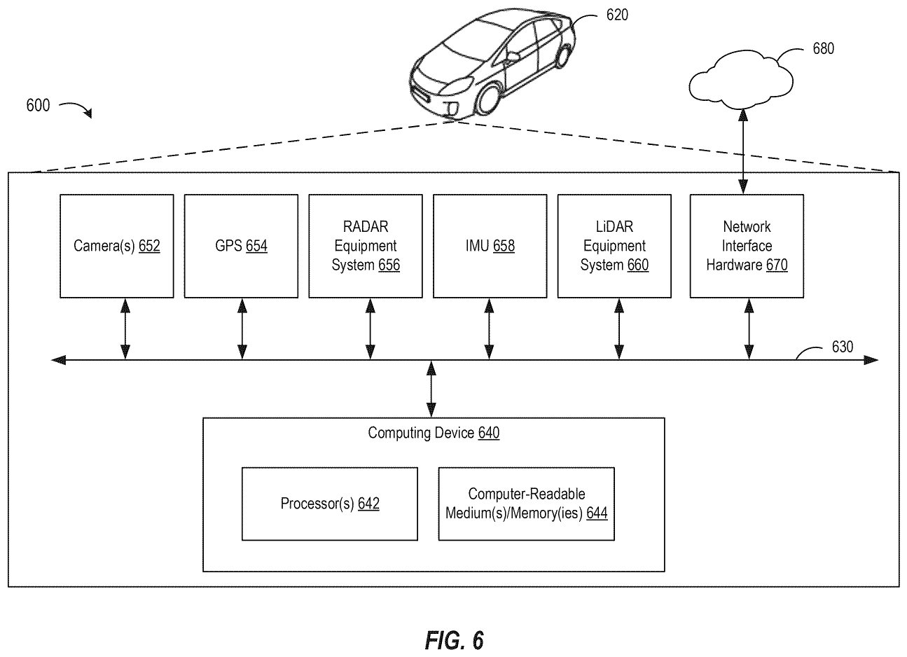

FIG. 6 depicts an example sensor and computing system 600 equipped, for example, in a vehicle 620 or other apparatus, such as a robot. The vehicle 620 depicted in FIG. 6 is depicted by way of an example schematic of a vehicle including sensor resources and a computing device. Not every vehicle may be required to be equipped with the same set of sensor resources, nor may every vehicle be required to be configured with the same set of systems for perceiving attributes of an environment. FIG. 6 only provides one example configuration of sensor resources and systems equipped within a vehicle 620. It is understood that aspects described herein are made with reference to implementation with, on, or in a vehicle 620. However, this is merely an example. The vehicle 620 may be any other apparatus.

In certain aspects, the computing system 600 of vehicle 620 may be configured to perform the method 500 described with respect to FIG. 5, or any aspect related to method 500, including any operations described in relation to FIGS. 1-3.

In particular, FIG. 6 provides an example schematic of the vehicle 620 including a variety of sensor resources, which may be utilized, by the vehicle 620 to perceive and collect sensor data about the environment. For example, the vehicle 620 may include a computing device 640 comprising one or more processors 642 and one or more non-transitory computer readable medium(s)/memory(ies) 644, one or more cameras 652, a global positioning system (GPS) 654, a RADAR equipment system 656, IMU 658, a LiDAR equipment system 660, and network interface hardware 670.

In certain aspects, the vehicle 620 may not include all of the components depicted in FIG. 6. In certain aspects, the vehicle 620 may include one or more of the components, such as the one or more cameras 652, the GPS 654, the RADAR equipment system 656, the IMU 658, the LiDAR equipment system 660, a SONAR system, and/or the like. These and other components of the vehicle 620 may be communicatively connected to each other via a communication path 630.

The communication path 630 may be formed from any medium that is capable of transmitting a signal such as, for example, conductive wires, conductive traces, optical waveguides, or the like. The communication path 630 may also refer to the expanse in which electromagnetic radiation and their corresponding electromagnetic waves traverses. Moreover, the communication path 630 may be formed from a combination of mediums capable of transmitting signals. In one embodiment, the communication path 630 comprises a combination of conductive traces, conductive wires, connectors, and buses that cooperate to permit the transmission of electrical data signals to components such as processors, memories, sensors, input devices, output devices, and communication devices. Accordingly, the communication path 630 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 640 may be any device or combination of components comprising one or more processors 642 and one or more non-transitory computer readable medium(s)/memory(ies) 644. The one or more processors 642 may be any device(s) capable of executing the processor-executable instructions stored in the one or more non-transitory computer readable medium(s)/memory(ies) 644. For example, each of the one or more processors 642 may be an electric controller, an integrated circuit, a microchip, a computer, or any other computing device. The one or more processors 642 are communicatively coupled to the other components of the vehicle 620 by the communication path 630. Accordingly, the communication path 630 may communicatively couple any number of processors 642 with one another, and allow the components coupled to the communication path 630 to operate in a distributed computing environment. Specifically, each of the components may operate as a node that may send and/or receive data.

The one or more non-transitory computer readable medium(s)/memory(ies) 644 may comprise RAM, ROM, flash memories, hard drives, or any non-transitory memory device capable of storing processor-executable instructions such that the processor-executable instructions can be accessed and executed by the one or more processors 642. The machine-readable instruction set may comprise logic or algorithm(s) written in any programming language of any generation (e.g., 1GL, 2GL, 3GL, 4GL, or 5GL, where GL stands for “generation language”) such as, for example, machine language that may be directly executed by the one or more processors 642, or assembly language, object-oriented programming (OOP), scripting languages, microcode, etc., that may be compiled or assembled into processor-executable instructions and stored in the one or more memories 644. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The vehicle 620 may further include one or more cameras 652. The one or more cameras 652 may be any device having an array of sensing devices (e.g., a charge-coupled device (CCD) array or active pixel sensors) capable of detecting radiation in an ultraviolet wavelength band, a visible light wavelength band, or an infrared wavelength band. The one or more cameras 652 may have any resolution. The one or more cameras 652 may be an omni-direction camera and/or a panoramic camera. In certain aspects, one or more optical components, such as a mirror, fish-eye lens, and/or any other type of lens may be optically coupled to the one or more cameras 652. The image data collected by the one or more cameras 652 may be stored in the one or more non-transitory computer readable medium(s)/memory(ies) 644.

GPS 654, may be coupled to the communication path 630 and communicatively coupled to the computing device 640 of the vehicle 620. The GPS 654 is capable of generating location information indicative of a location of the vehicle 620 by receiving one or more GPS signals from one or more GPS satellites. The GPS signal communicated to the computing device 640 via the communication path 630 may include location information including a message, a latitude and longitude data set, a street address, a name of a known location based on a location database, and/or the like. Additionally, the GPS 654 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 654 may be stored in the one or more non-transitory computer readable medium(s)/memory(ies) 644.

RADAR equipment system 656 measures the distance to objects over wide distances. It is also possible to measure the relative speed of the detected object. The RADAR equipment system 656 may be a continuous wave (CW), frequency-modulated continuous wave (FMCW), 3D-radio detection and ranging equipment (3D FMCW multiple-input and multiple-output (MIMO)), or 4D-radio detection and ranging equipment (4D FMCW MIMO). The sensor data collected by the RADAR equipment system 656 may be stored in the one or more non-transitory computer readable medium(s)/memory(ies) 644.

IMU 658 is an electronic device that measures and reports vehicle 620's specific force, angular rate, and/or the orientation of the vehicle 620, using a combination of accelerometers, gyroscopes, and/or magnetometers. The sensor data collected by the IMU 658 may be stored in one or more non-transitory computer readable medium(s)/memory(ies) 644.

LiDAR equipment system 660 is communicatively coupled to the communication path 630 and the computing device 640. LiDAR equipment system 660 may be a system and method of using pulsed laser light to measure distances from the LiDAR equipment system 660 to objects that reflect the pulsed laser light. A LiDAR equipment system 660 may be made as solid-state devices with few or no moving parts, including those configured as optical phased array devices where its prism-like operation permits a wide field-of-view without the weight and size complexities associated with a traditional rotating LiDAR equipment system 660. LiDAR equipment system 1460 may be particularly suited to measuring time-of-flight, which in turn may be correlated to distance measurements with object(s) that are within a field-of-view of the LiDAR equipment system 660. By calculating the difference in return time of the various wavelengths of the pulsed laser light emitted by the LiDAR equipment system 660, a digital 3D representation of an object and/or or environment may be generated. The pulsed laser light emitted by the LiDAR equipment system 660 may include emissions operated in and/or near the infrared range of the electromagnetic spectrum, for example, having emitted radiation of about 905 nanometers. Vehicle 620 may use LiDAR equipment system 660 to provide detailed 3D spatial information for the identification of object(s) near the vehicle 620, as well as the use of such information in the service of systems for vehicular mapping, navigation and autonomous operations. In certain aspects, period cloud data collected by the LiDAR equipment system 660 may be stored in the one or more non-transitory computer readable medium(s)/memory(ies) 644.

In certain aspects, vehicle 620 may be equipped with a vehicle-to-vehicle (V2V) communication system, which may rely on network interface hardware 670. The network interface hardware 670 may be coupled to the communication path 630 and communicatively coupled to the computing device 1440. The network interface hardware 670 may be any device capable of transmitting and/or receiving data with a network 680 and/or directly with another vehicle equipped with a V2V communication system. Accordingly, network interface hardware 670 can include a communication transceiver for sending and/or receiving any wired and/or wireless communication. For example, the network interface hardware 670 may include an antenna, a modem, a local area network (LAN) port, a Wi-Fi card, a worldwide interoperability for microwave access (WiMax) card, mobile communications hardware, near-field communication (NFC) hardware, satellite communication hardware, and/or any wired or wireless hardware for communicating with other networks and/or devices. In certain aspects, network interface hardware 670 includes hardware configured to operate in accordance with the Bluetooth wireless communication protocol. In certain aspects, network interface hardware 670 may include a Bluetooth send/receive module for sending and/or receiving Bluetooth communications to/from network 680 and/or another vehicle or device.

### Example Apparatus for Static Object Information Generation

FIG. 7 depicts aspects of an example apparatus 700. In certain aspects, apparatus 700 is a computing device, such as server 112 of FIG. 1, server 212 of FIG. 2, and/or server 310 of FIG. 3.

The apparatus 700 includes a processing system 705, which may be coupled to a transceiver 775 (e.g., a transmitter and/or a receiver). The transceiver 775 is configured to transmit and receive signals for the apparatus 700 via an antenna 780, such as the various signals as described herein. The processing system 705 may be configured to perform processing functions for the apparatus 700, including processing signals received and/or to be transmitted by the apparatus 700.

The processing system 705 includes one or more processors 710. Generally, processor(s) 710 may be configured to execute computer-executable instructions (e.g., software code) to perform various functions, as described herein. The one or more processors 710 are coupled to a computer-readable medium/memory 740 via a bus 770. In certain aspects, the computer-readable medium/memory 740 is configured to store instructions (e.g., computer-executable code) that when executed by the one or more processors 710, enable and cause the one or more processors 710 to perform the method 400 described with respect to FIG. 4, or any aspect related to method 400, including any operations described in relation to FIGS. 1-3. Note that reference to a processor performing a function of the apparatus 700 may include one or more processors performing that function of the apparatus 700, such as in a distributed fashion.

In the depicted example, computer-readable medium/memory 740 stores code 731 for obtaining, code 732 for querying, code 733 for generating, code 734 for outputting, code 735 for determining, code 736 for selecting, code 737 for simulating, and code 738 for receiving. Processing of the code 731-738 may enable and cause the apparatus 700 to perform the method 400 described with respect to FIG. 4, or any aspect related to method 400, including any operations described in relation to FIGS. 1-3.

The one or more processors 710 include circuitry configured to implement (e.g., execute) the code stored in the computer-readable medium/memory 740, including circuitry 721 for obtaining, circuitry 722 for querying, circuitry 723 for generating, circuitry 724 for outputting, circuitry 725 for determining, circuitry 726 for selecting, circuitry 727 for simulating, and circuitry 728 for receiving. Processing with circuitry 721-728 may enable and cause the apparatus 700 to perform the method 400 described with respect to FIG. 4, or any aspect related to method 400, including any operations described in relation to FIGS. 1-3.

Apparatus 700 may be implemented in various ways. For example, apparatus 700 may be implemented within on-site, remote, or cloud-based processing equipment.

Apparatus 700 is just one example, and other configurations are possible. For example, in alternative aspects, aspects described with respect to apparatus 700 may be omitted, added, or substituted for alternative aspects.

### Example Apparatus for Object Detection

FIG. 8 depicts aspects of another example apparatus 800. In certain aspects, apparatus 800 is a computing device, such as computing device 640 depicted and described with respect to FIG. 6 (e.g., which may or may not be implemented by a vehicle 620).

The apparatus 800 includes a processing system 805, which may be coupled to a transceiver 875 (e.g., a transmitter and/or a receiver). The transceiver 875 is configured to transmit and receive signals for the apparatus 800 via an antenna 880, such as the various signals as described herein. The processing system 805 may be configured to perform processing functions for the apparatus 800, including processing signals received and/or to be transmitted by the apparatus 800.

The processing system 805 includes one or more processors 810. Generally, processor(s) 810 may be configured to execute computer-executable instructions (e.g., software code) to perform various functions, as described herein. The one or more processors 810 are coupled to a computer-readable medium/memory 841 via a bus 870. In certain aspects, the computer-readable medium/memory 841 is configured to store instructions (e.g., computer-executable code) that when executed by the one or more processors 810, enable and cause the one or more processors 810 to perform the method 500 described with respect to FIG. 5, or any aspect related to method 500, including any operations described in relation to FIGS. 1-3. Note that reference to a processor performing a function of the apparatus 800 may include one or more processors performing that function of the apparatus 800, such as in a distributed fashion.

In the depicted example, computer-readable medium/memory 841 stores code 831 for sending, code 832 for receiving, code 833 for processing, code 834 for obtaining, code 835 for representing, code 836 for generating, code 837 for outputting, code 838 for identifying, code 839 for removing, and code 840 for inpainting. Processing of the code 831-840 may enable and cause the apparatus 800 to perform the method 400 described with respect to FIG. 5, or any aspect related to method 500, including any operations described in relation to FIGS. 1-3.

The one or more processors 810 include circuitry configured to implement (e.g., execute) the code stored in the computer-readable medium/memory 841, including circuitry 821 for sending, circuitry 822 for receiving, circuitry 823 for processing, circuitry 824 for obtaining, circuitry 825 for representing, circuitry 826 for generating, circuitry 827 for outputting, circuitry 828 for identifying, circuitry 829 for removing, and circuitry 830 for inpainting. Processing with circuitry 821-830 may enable and cause the apparatus 800 to perform the method 500 described with respect to FIG. 5, or any aspect related to method 500, including any operations described in relation to FIGS. 1-3.

Apparatus 800 may be implemented in various ways. For example, apparatus 800 may be implemented within on-site, remote, or cloud-based processing equipment.

Apparatus 800 is just one example, and other configurations are possible. For example, in alternative aspects, aspects described with respect to apparatus 800 may be omitted, added, or substituted for alternative aspects.

### Example Clauses

Implementation examples are described in the following numbered clauses:

Clause 1: A method for frame generation, comprising: obtaining a first frame, captured by a sensor from a first viewing angle, representing one or more static objects in a scene during a first time period, wherein the one or more static objects comprise a first static object; querying a data structure associated with a global map comprising a plurality of sub-maps representing the scene for the first time period to identify a first sub-map of the plurality of sub-maps associated with a location of the sensor for the first time period; generating a second frame based on the first sub-map, the location of the sensor, and the first viewing angle of the sensor, the second frame representing at least the first static object in the scene during the first time period; and outputting the second frame.

Clause 2: The method of Clause 1, wherein the second frame is configured for use for object detection of at least the first static object in the scene.

Clause 3: The method of any one of Clauses 1-2, wherein: the first frame represents the first static object with a first level of detail; and the second frame represents the first static object with a second level of detail that is greater than the first level of detail.

Clause 4: The method of any one of Clauses 1-3, wherein: the first frame is associated with a first focal length; and the second frame is associated with a second focal length that is greater than the first focal length.

Clause 5: The method of any one of Clauses 1-4, wherein querying the data structure to identify the first sub-map comprises: determining a respective distance between the location of the sensor and a respective centroid of each sub-map of the plurality of sub-maps to generate a plurality of distances; and selecting the first sub-map based on the respective distance between the location of the sensor and the respective centroid of the first sub-map being a smallest distance among the plurality of distances.

Clause 6: The method of any one of Clauses 1-5, wherein: the first frame comprises a first set of points; and generating the second frame comprises: generating a third frame based on the first sub-map, the location of the sensor, and the first viewing angle of the sensor, the third frame comprising a second set of points; generating a homography matrix indicating a correspondence between the first set of points of the first frame and the second set of points of the third frame; and generating the second frame based on the first frame and the homography matrix.

Clause 7: The method of Clause 6, wherein generating the homography matrix comprises: generating the homography matrix based on feature matching and a RANSAC algorithm.

Clause 8: The method of any one of Clauses 1-7, further comprising: obtaining the plurality of sub-maps, wherein each respective sub-map of the plurality of sub-maps is associated with a respective entity of a plurality of entities; simulating a plurality of trajectories for the plurality of entities based on, for each respective entity: simulating a respective plurality of trajectories for the respective entity from the respective sub-map associated with the respective entity to each other sub-map of the plurality of sub-maps; and determining an alignment for the plurality of sub-maps based on solving a non-linear optimization problem to reduce a re-projection error across the plurality of trajectories; and generating the global map comprising the plurality of sub-maps based on the alignment.

Clause 9: The method of any one of Clauses 1-8, wherein: the plurality of sub-maps comprise a plurality of 3D Gaussian kernels; and the method further comprises receiving one or more updates to one or more weights associated with one or more 3D Gaussian kernels of the plurality of 3D Gaussian kernels.

Clause 10: The method of any one of Clauses 1-9, wherein the first static object comprises a traffic element.

Clause 11: A method for object detection, comprising: sending a first frame, captured by a sensor from a first viewing angle, representing one or more static objects in a scene during a first time period, wherein the one or more static objects comprise a first static object; sending an indication of the first viewing angle and a location of the sensor associated with the first time period; receiving a second frame representing at least the first static object in the scene during the first time period, wherein the second frame is associated with the first viewing angle and a location of the sensor for the first time period; and processing the second frame to detect at least the first static object in the scene.

Clause 12: The method of Clause 11, further comprising: obtaining a plurality of frames captured by one or more sensors, wherein the plurality of frames comprise a plurality of samples representing at least a plurality of static objects in the scene; representing the plurality of samples as a plurality of three-dimensional (3D) Gaussian kernels; generating a sub-map comprising the plurality of 3D Gaussian kernels; and outputting the sub-map.

Clause 13: The method of Clause 12, wherein: the plurality of frames comprise the plurality of samples representing the plurality of static objects and one or more dynamic objects in the scene; and the method further comprises: identifying at least one sample of the plurality of samples associated with the one or more dynamic objects in the scene; removing the at least one sample from the plurality of frames; and inpainting at least one location in the plurality of frames associated with the at least one sample removed from the plurality of frames.

Clause 14: The method of any one of Clauses 12-13, wherein the plurality of samples comprise at least one of: a plurality of points associated with a plurality of point clouds; a plurality of pixels associated with a plurality of images; a plurality of accelerometer values associated with a first plurality of time periods; or a plurality of gyroscope values associated with a second plurality of time periods.

Clause 15: The method of any one of Clauses 12-14, further comprising: sending one or more updates to one or more weights associated with one or more 3D Gaussian kernels of the plurality of 3D Gaussian kernels of the sub-map.

Clause 16: The method of any one of Clauses 11-15, wherein: the first frame represents the first static object with a first level of detail; and the second frame represents the first static object with a second level of detail that is greater than the first level of detail.

Clause 17: The method of any one of Clauses 11-16, wherein: the first frame is associated with a first focal length; and the second frame is associated with a second focal length that is greater than the first focal length.

Clause 18: The method of any one of Clauses 11-17, wherein the first static object comprises a traffic element.

Clause 19: One or more apparatuses, comprising: one or more memories comprising executable instructions; and one or more processors configured to execute the executable instructions and cause the one or more apparatuses to perform a method in accordance with any one of clauses 1-18.

Clause 20: One or more apparatuses, comprising: one or more memories; and one or more processors, coupled to the one or more memories, configured to cause the one or more apparatuses to perform a method in accordance with any one of Clauses 1-18.

Clause 21: One or more apparatuses, comprising: one or more memories; and one or more processors, coupled to the one or more memories, configured to perform a method in accordance with any one of Clauses 1-18.

Clause 22: One or more apparatuses, comprising means for performing a method in accordance with any one of Clauses 1-18.

Clause 23: One or more non-transitory computer-readable media comprising executable instructions that, when executed by one or more processors of one or more apparatuses, cause the one or more apparatuses to perform a method in accordance with any one of Clauses 1-18.

Clause 24: One or more computer program products embodied on one or more computer-readable storage media comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
obtain a first frame, captured by a sensor from a first viewing angle, representing one or more static objects in a scene during a first time period, wherein the one or more static objects comprise a first static object;
query a data structure associated with a global map comprising a plurality of sub-maps representing the scene for the first time period to identify a first sub-map of the plurality of sub-maps associated with a location of the sensor for the first time period;
generate a second frame based on the first sub-map, the location of the sensor, and the first viewing angle of the sensor, the second frame representing at least the first static object in the scene during the first time period; and
output the second frame.

2. The apparatus of claim 1, wherein the second frame is configured for use for object detection of at least the first static object in the scene.

3. The apparatus of claim 1, wherein:
the first frame represents the first static object with a first level of detail; and
the second frame represents the first static object with a second level of detail that is greater than the first level of detail.

4. The apparatus of claim 1, wherein:
the first frame is associated with a first focal length; and
the second frame is associated with a second focal length that is greater than the first focal length.

5. The apparatus of claim 1, wherein to cause the apparatus to query the data structure to identify the first sub-map, the processing system is configured to cause the apparatus to:
determine a respective distance between the location of the sensor and a respective centroid of each sub-map of the plurality of sub-maps to generate a plurality of distances; and
select the first sub-map based on the respective distance between the location of the sensor and the respective centroid of the first sub-map being a smallest distance among the plurality of distances.

6. The apparatus of claim 1, wherein:
the first frame comprises a first set of points; and
to cause the apparatus to generate the second frame, the processing system is configured to cause the apparatus to:
generate a third frame based on the first sub-map, the location of the sensor, and the first viewing angle of the sensor, the third frame comprising a second set of points;
generate a homography matrix indicating a correspondence between the first set of points of the first frame and the second set of points of the third frame; and
generate the second frame based on the first frame and the homography matrix.

7. The apparatus of claim 6, wherein to cause the apparatus to generate the homography matrix, the processing system is configured to cause the apparatus to:
generate the homography matrix based on feature matching and a random sample consensus (RANSAC) algorithm.

8. The apparatus of claim 1, wherein the processing system is configured to cause the apparatus to:
obtain the plurality of sub-maps, wherein each respective sub-map of the plurality of sub-maps is associated with a respective entity of a plurality of entities;
simulate a plurality of trajectories for the plurality of entities based on, for each respective entity:
simulating a respective plurality of trajectories for the respective entity from the respective sub-map associated with the respective entity to each other sub-map of the plurality of sub-maps; and
determine an alignment for the plurality of sub-maps based on solving a non-linear optimization problem to reduce a re-projection error across the plurality of trajectories; and
generate the global map comprising the plurality of sub-maps based on the alignment.

9. The apparatus of claim 1, wherein:
the plurality of sub-maps comprise a plurality of three-dimensional (3D) Gaussian kernels; and
the processing system is configured to cause the apparatus to receive one or more updates to one or more 3D Gaussian kernels of the plurality of 3D Gaussian kernels.

10. The apparatus of claim 1, wherein the first static object comprises a traffic element.

11. A method for frame generation, comprising:
obtaining a first frame, captured by a sensor from a first viewing angle, representing one or more static objects in a scene during a first time period, wherein the one or more static objects comprise a first static object;
querying a data structure associated with a global map comprising a plurality of sub-maps representing the scene for the first time period to identify a first sub-map of the plurality of sub-maps associated with a location of the sensor for the first time period;
generating a second frame based on the first sub-map, the location of the sensor, and the first viewing angle of the sensor, the second frame representing at least the first static object in the scene during the first time period; and
outputting the second frame.

12. The method of claim 11, wherein the second frame is configured for use for object detection of at least the first static object in the scene.

13. The method of claim 11, wherein:
the first frame represents the first static object with a first level of detail; and
the second frame represents the first static object with a second level of detail that is greater than the first level of detail.

14. The method of claim 11, wherein:
the first frame is associated with a first focal length; and
the second frame is associated with a second focal length that is greater than the first focal length.

15. The method of claim 11, wherein querying the data structure to identify the first sub-map comprises:
determining a respective distance between the location of the sensor and a respective centroid of each sub-map of the plurality of sub-maps to generate a plurality of distances; and
selecting the first sub-map based on the respective distance between the location of the sensor and the respective centroid of the first sub-map being a smallest distance among the plurality of distances.

16. The method of claim 11, wherein:
the first frame comprises a first set of points; and
generating the second frame comprises:
generating a third frame based on the first sub-map, the location of the sensor, and the first viewing angle of the sensor, the third frame comprising a second set of points;
generating a homography matrix indicating a correspondence between the first set of points of the first frame and the second set of points of the third frame; and
generating the second frame based on the first frame and the homography matrix.

17. The method of claim 16, wherein generating the homography matrix comprises:
generating the homography matrix based on feature matching and a random sample consensus (RANSAC) algorithm.

18. The method of claim 11, further comprising:
obtaining the plurality of sub-maps, wherein each respective sub-map of the plurality of sub-maps is associated with a respective entity of a plurality of entities;
simulating a plurality of trajectories for the plurality of entities based on, for each respective entity:
simulating a respective plurality of trajectories for the respective entity from the respective sub-map associated with the respective entity to each other sub-map of the plurality of sub-maps; and
determining an alignment for the plurality of sub-maps based on solving a non-linear optimization problem to reduce a re-projection error across the plurality of trajectories; and
generating the global map comprising the plurality of sub-maps based on the alignment.

19. The method of claim 11, wherein:
the plurality of sub-maps comprise a plurality of three-dimensional (3D) Gaussian kernels; and
the method further comprises receiving one or more updates to one or more 3D Gaussian kernels of the plurality of 3D Gaussian kernels.

20. One or more non-transitory computer-readable media comprising executable instructions that, when executed by one or more processors of an apparatus, cause the apparatus to perform operations comprising:
obtaining a first frame, captured by a sensor from a first viewing angle, representing one or more static objects in a scene during a first time period, wherein the one or more static objects comprise a first static object;
querying a data structure associated with a global map comprising a plurality of sub-maps representing the scene for the first time period to identify a first sub-map of the plurality of sub-maps associated with a location of the sensor for the first time period;
generating a second frame based on the first sub-map, the location of the sensor, and the first viewing angle of the sensor, the second frame representing at least the first static object in the scene during the first time period; and
outputting the second frame.
